(19) United States
(12) Patent Application Publication
(10) Pub. No.: US 2005/0204466 A1
(43) Pub. Date: Sep. 22, 2005

(54) Pedicure chair spa with footrest

(76) Inventor: Mike Luong, El Dorado Hills, CA (US)

Correspondence Address: O'BANION & RITCHEY, LLP;JOHN P. O'BANION, 400 CAPITAL MALL, SUITE 1550, SACRAMENTO, CA, 95814, US

(21) Appl. No.: 10/800,849

(22) Filed: Mar. 16, 2004

(51) Int. Cl. E03C 1/00; A47K 3/022; A61H 35/00

(52) U.S. Cl. 4/622

(57) ABSTRACT

A pedicure spa chair base for use with any seat, which chair base has a basin having a raised area and a lowered area therein, the raised area having a pair of mirror image footrest sections separated by a part of the lowered section which part has the drain for the basin therein. The lowered area of the basin has a horizontally disposed water jet forwardly of each footrest. Each footrest also includes a forwardly disposed extension, adjacent each respective water jet. Other conventional components including a seat mount are found on the chair base.

### FIELD OF THE INVENTION

This invention pertains to the field of pedicure spa chairs and foot grooming.

### BACKGROUND OF THE INVENTION

As more and more people become accustomed to having their nails done, particularity their feet and toenails, customers are demanding more amenities be present during the pedicure treatment. Witness the pending patent application for a media tray filed by applicant to retain a CD player or DVD viewer. Another such amenity is the one of this application.

Sometimes during the foot grooming process, a customer may want to adjust their feet away from hydro-jets, or perhaps during the period when their fingernails are being treated. Or they may also want the benefit of a jet dispatching water on the underside or base of the foot. The invention of this application permits both to transpire at the whim of the customer.

The invention accordingly comprises a device possessing the features properties and the relation of components which are exemplified in the following detailed disclosure and the scope of the application of which will be indicated in the appended claims.

For a fuller understanding of the nature and objects of the invention reference should be made to the following detailed description, taken in conjunction with the accompanying drawings.

### BRIEF DESCRIPTION OF THE FIGURES

FIG. 1 is a top perspective view of the pedicure chair base of this invention.

FIG. 2 is a front elevational view thereof.

FIG. 3 is a perspective view of a full pedicure spa chair utilizing the base of this invention.

FIG. 4 is a control panel used for the operation of the pedicure spa chair of this invention.

FIG. 5 is a top plan view of an alternate configuration of the pedicure chair water receiving area according to this invention.

### SUMMARY OF THE INVENTION

A pedicure spa chair base that can be configured round, square or otherwise that provides a raised shelf rest for each foot within the confines of the spa zone, and provide a water jet that massages the underside of the foot merely by sliding the foot laterally. The jets are recessed such that the emission of water from the jet is not impeded by the location of the foot. Each foot can either rest or be massaged independently or undergo pedicure treatment.

It is an object therefore to provide a pedicure chair base capable of utilizing almost any chair seat portion thereon.

It is a second object to provide a pedicure spa chair wherein each foot can rest on a shelf, be massaged by a water jet, or treated by a technician.

It is a third object to provide a pedicure chair spa that has a basin capacity of only six gallons rather than the standard eight gallons.

It is a fourth object to provide a pedicure chair spa that is pleasurable to the customer.

It is a fifth object to provide a pedicure chair spa base that can be used with any appropriate pedicure chair controller system.

These and other objects will become obvious from a careful reading of this specification taken in conjunction with the various figures and the appended claims.

### DESCRIPTION OF THE PREFERRED EMBODIMENT

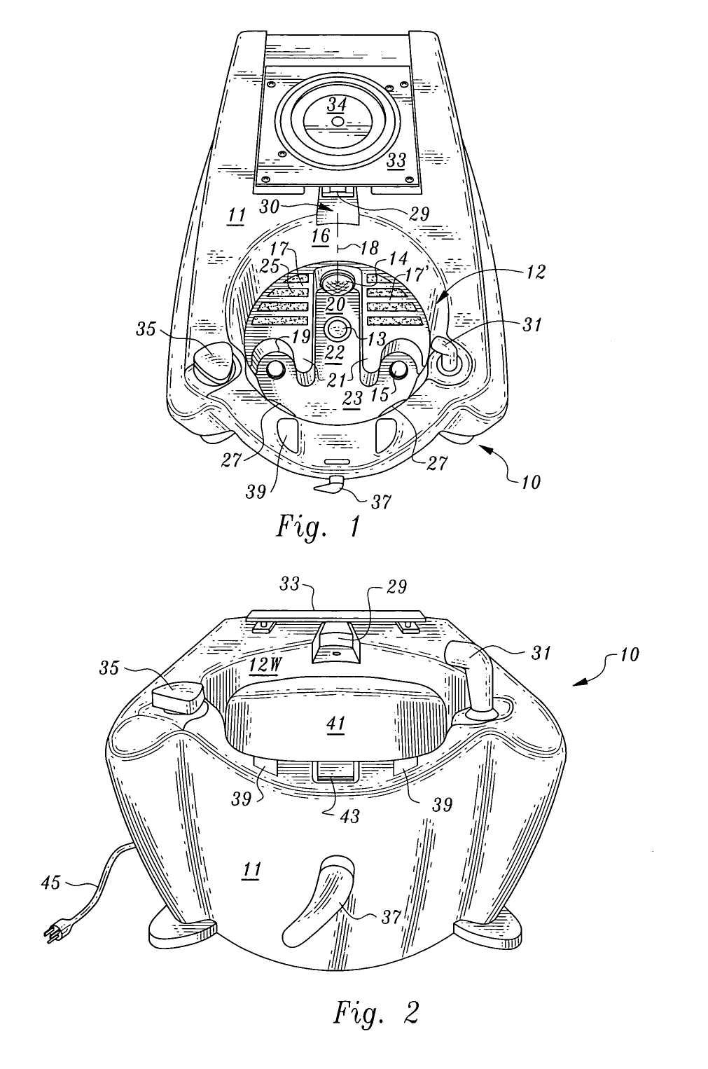

In FIG. 1, there is seen a base for a pedicure chair. By the term “base” is meant that any suitable seat portion can be attached to the apparatus upon the seat mount 33 of the pedicure chair base of this invention Pedicure spa base 10 has a blow molded or vacuum formed body 11, as is conventional in this industry. This body 11 includes a basin 12 defined by sidewalls 12W, which basin serves as a water holding zone. The basin includes an elevated member comprising a pair of mirror image footrest sections 17, 17′ and a lower zone 20. The invisible line 18, which is a center axis line, separates the right footrest section 17 from its left counterpart 17′. Each section of the footrest is generally triangular and includes a forwardly directed extension 21. These elevated footrest sections permit the user to rest their respective left and/or right foot during periods of nontreatment, or to just soak their feet if the water level is high enough to cover the feet. The elevated footrest sections 17,17′, also permits the basin or water holding zone to be filled using only six gallons of water while most conventional pedicure spas require eight gallons. Each footrest 17,17′ may include raised treads 25 to prevent the respective foot from slipping during entry or egress.

The balance of the topography of the water receiving area 12 is the recessed section 23, which is configured to generally resemble a cactus, but can be manufactured in other shapes as well. See FIG. 5 for a configuration variant wherein like numbers refer to like functional parts but all numbers are within the 100 series.

The recessed section of the first embodiment 23 is seen to have three arms, one long arm 22 positioned in-between two shorter arms of equal length designated 19. Each of the shorter arms 19 has a conventional water jet 15 centrally disposed horizontally, while the center arm includes a drain 13 which is similar to those used in household sinks, and which drain is activated by rotating or pulling the specific drain release 35 employed, which release is shown in an upright location across from the hose spray 31 discussed infra. Any conventional drain pull used in the industry can be used to raise or lower the drain plug 13 to drain water from the basin 12.

In a vertical disposition at the very rear of the center arm 22, between the two footrest sections 17,17′ is the suction input 14 which is connected to the pump for the jets, which pump is unseen. Such suction input is necessary for the jets to function properly. The use of suction input is well recognized in this art.

Also seen in this top perspective view, conveniently located adjacent the basin, is a hose spray 31 similar to those used in a kitchen sink. This hose spray telescopes and recesses back into a bore and is used for rinsing any creams, soap, lotions or old nail polish from an untreated foot, and may be used, if necessary, in the manual cleaning of the basin 12.

A single handle faucet 37 is used to control the temperature of the incoming water. Upon actuation of faucet 37, water is released from water intake 29, flows into trough 30, and down into the basin 12. While not shown, a level control system with a float can be utilized to shut off the water when a predetermined height level has been reached.

Disposed forwardly within the basin and vertically on the sidewall 16 of the basin at the front thereof is a pair of spaced water jets 27. By being vertically disposed, one can have the water from the jet impact the underside of the user's foot when the foot is raised up.

One of the most impressive features of this pedicure chair base is the presence of the extensions 21 on each footrest 17. These extensions are intended to support the front part of the foot as well as the toes when the foot is in the rest position on the footrest 17,17′. The spa user can then pivot the foot with the heel on each respective extension 21 and have fluid from jet 15 hit the underside of the foot. Or, the user can pivot the respective foot to a somewhat vertical position with the heel and rear of the foot resting on the respective extension 21, and the big toe pointing upwardly, such that water from jet 27, the forward vertically disposed jet, can impact the underside of the respective foot, as may be desired.

Shown molded into the body 11 at the front thereof, is a pair of upstanding bumpers 39 upon which a cushion used for foot treatment is to be disposed. This cushion 41 is seen after installation, in FIG. 2. Disposed at the very front of the base 12 is the single handle faucet 37, previously discussed, for turning the water for the basin on and off.

Disposed rearwardly of the water intake 29 is the seat mount 33 which has a partially rotatable Lazy Susan 34 to which the actual seat, not seen, is mounted to permit the seat to rotate leftwardly and rightwardly as may be desired by the user. Any chair seat suitable for use on a pedicure spa may be employed with this invention.

Reference is now made to FIG. 2. The cord and plug 45 are used to operate the pumps to create the hydro therapeutic action of the spa's jets. Footrest 41 is seen in an raised position, held in this elevated position by pivoting footrest raiser 43. In the lowered position as shown, the cushion 41 rests upon the bumpers 39. Chair mount 33 is better seen in this view.

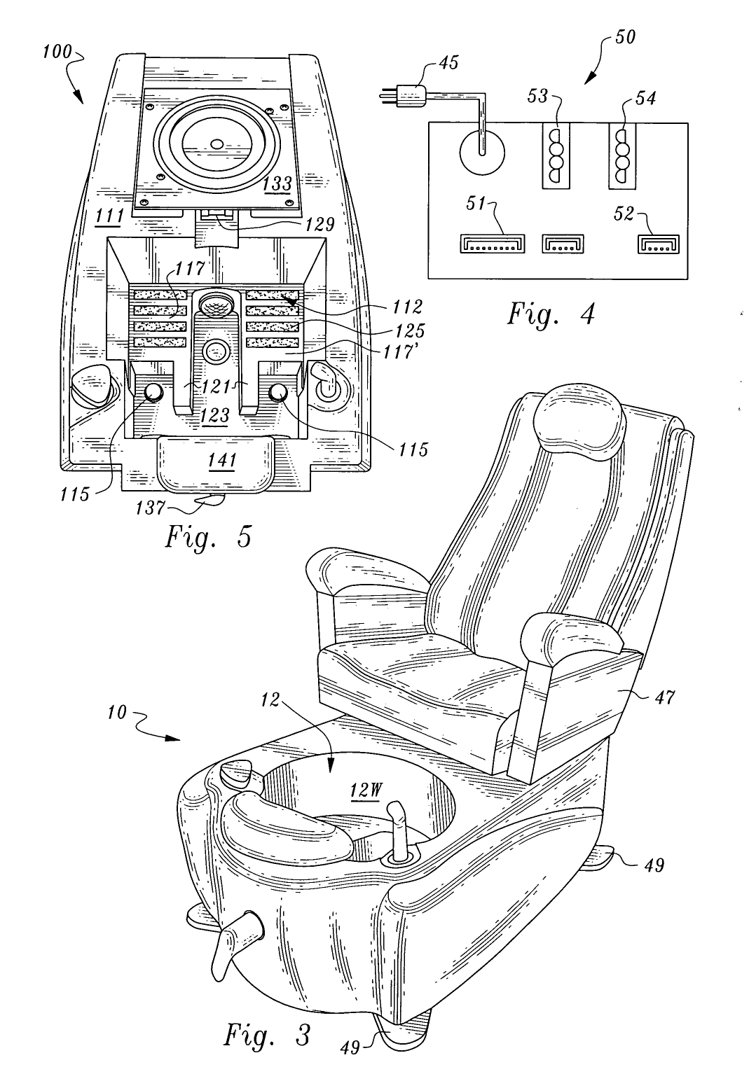

In FIG. 3, the invention base 10 is seen with a typical seat 47 shown attached to the seat mount 39—not visible here. Since no other elements shown in this figure lack a previous description, no further reference numerals have been included other than those for the legs 49, three of which are visible in this view.

In FIG. 4, a typical control panel for the operation of this spa base or any spa base is seen. A keypad 51 for inputting data such as time and temperature is seen, as is a temperature probe connection 52 for readout of the water temperature of the basin 12. Whirlpool pump and water discharge pump connections 53,54 respectively are shown on this control panel. Typical control panels for pedicure spas are made by Gecko Electronics of San Marcos, Calif. among others.

In FIG. 5, a second cosmetically different pedicure chair base 100 according to this invention is seen. All of the parts discussed previously are shown here as well and numbered in the 100 series. The basin 112 is generally square rather than round as is the previously discussed unit. The extensions 121 are shown a bit more pointed than their counterparts 21 aforementioned. Seat base 133 also has the rotational mounting capability. The feet for this unit are not visible in this top view. Other configurations for the basin with the same elements, and changes to the overall shape of the base are also contemplated.

It is seen that I have created a new pedicure spa base suitable for use with any seat that can be attached to the seat mount previously discussed. As noted, the big advantages of this spa base are the ability to save water—needing only 6 gallons for a full foot soak versus 8 gallons for most available units of the marketplace, the raised footrests and their extensions provide the ability to save water by reducing the overall volume of the basin 12, but these elements also permit the pivotal moving of the foot for jet impact or not as may be desired. Not only jet impact, but jet impact from two different jet sources. The raised treads on the footrests make it safer and perhaps easier for entry and egress from the pedicure spa chair of this invention by reducing slippage.

Since certain changes may be made in the described apparatus without departing from the scope of the invention herein involved, it is intended that all matter contained in the above description and shown in the accompanying drawings shall be interpreted as illustrative and not in a limiting sense.

1. A pedicure spa chair base suitable for use with any suitable seat, which chair base has a basin defined by upstanding sidewalls, said basin having a lowered zone and a raised zone, the latter comprising a pair of mirror image footrests separated by a part of the lowered zone, which part has the drain for the basin therein, and said basin's lower zone also having a horizontally disposed water jet disposed forwardly of each footrest.

2. The pedicure chair base of claim 1 wherein each footrest has a raised tread thereon to reduce slippage.

3. The pedicure chair base of claim 1 wherein each footrest is generally triangular.

4. The pedicure chair base of claim 1 further including a forward projecting extension on each footrest, each of which extension is spaced from said sidewalls, with the respective horizontally disposed water jet disposed between the sidewall and the respective extension.

5. The pedicure chair base of claim 4 wherein each footrest has a raised tread thereon to reduce slippage.

6. The pedicure chair of claim 5 further including a pair of spaced water jets mounted on a sidewall of said basin.

7. A pedicure spa chair base suitable for use with any suitable seat, which chair base has a basin defined by upstanding sidewalls, said basin having a lowered zone and a raised zone, the latter comprising a pair of mirror image raised tread bearing footrests, each footrest having a forward projecting extension, said footrests and said extensions being separated by a part of the lowered zone, each of which extension is spaced from a sidewall of said basin;
said basin's lower zone also having a horizontally disposed water jet disposed both forwardly of each footrest, and between a sidewall and an extension.

8. The pedicure spa chair base of claim 7 wherein a drain for the basin is disposed in the lowered zone between said footrests.

9. The pedicure spa chair base of claim 8 further including a chair mount that permits a seat mounted thereon to rotate from side to side.

10. The pedicure chair of claim 8, further including a pair of spaced vertically disposed water jets mounted on a basin sidewall.

11. The pedicure spa chair base of claim 3 further including a chair mount that permits a seat mounted thereon to rotate from side to side.

12. The pedicure spa chair base of claim 7 wherein the basin is configured round.

13. The pedicure spa chair base of claim 7 wherein the basin is configured square.

14. The pedicure spa chair base of claim 11 having a seat attached to said seat mount.

15. A pedicure chair comprising a seat attached to a chair base which base has a circular basin defined by an upstanding sidewall, said basin having a lowered zone and a raised zone, the latter comprising a pair of mirror image raised tread bearing footrests, each footrest having a forward projecting extension, said footrests and said extensions being separated by a part of the lowered zone, each of which extensions is spaced from the sidewall of said basin;
said basin's lower zone also having a horizontally disposed water jet disposed both forwardly of each footrest and between the sidewall, and an extension and having a pair of spaced vertically disposed water jets mounted on the basin sidewall.

16. The chair base of claim 1 further including a front bumper, and a water faucet.

17. The chair base of claim 15 further including a raisable front bumper, and a water faucet.
